(19) United States
(12) Patent Application Publication
(10) Pub. No.: US 2008/0180199 A1
(43) Pub. Date: Jul. 31, 2008

(54) Radiation-crosslinked thermoplastics in an electrical installation switching device

(75) Inventors: Patrick Claeys, Darmstadt (DE); Jurgen Hofmann, Einhausen (DE); Richard Hack, Nussloch (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/076,108

(22) Filed: Mar. 13, 2008

Related U.S. Application Data
(63) Continuation of application No. PCT/EP2006/008227, filed on Aug. 22, 2006.

(30) Foreign Application Priority Data
Sep. 17, 2005 (DE) 10 2005 044 540.3

(51) Int. Cl. H01H 9/02

(52) U.S. Cl. 335/202

(57) ABSTRACT

The disclosure relates to an electrical installation device, e.g., a circuit-breaker, motor protecting switch, and similar, comprising a housing that is formed from shell-type housing parts, an electromagnetic trigger, a thermal trigger, a breaker mechanism with a latching point, a slide which transmits the movements of the thermal trigger and the magnetic trigger to the breaker mechanism in order to unlatch the same, and a striker that is connected to the armature of the electromagnetic trigger and acts upon a movable contact piece of a contact point in case of a short-circuit so as to open the contact point. The shell-type housing parts, the slide, and the striker are made of plastic. At least the slide is formed from radiation-crosslinked thermoplastic to which an additive has been added as a crosslinking promoter before the radiation process.

### RELATED APPLICATIONS

This application claims priority under 35 U.S.C. §119 to German Application No. 10 2005 044 540.3 filed in Germany on 17 Sep. 2005, and as a continuation application under 35 U.S.C. §120 to PCT/EP2006/008227 filed as an International Application on 22 Aug. 2006 designating the U.S., the entire contents of which are hereby incorporated by reference in their entireties.

### TECHNICAL FIELD

An electrical installation switching device is disclosed, e.g., a line circuit breaker or a motor circuit breaker or the like.

### BACKGROUND INFORMATION

Details will be given in the text which follows substantially on a line circuit breaker, but the disclosure can also be applied in motor circuit breakers, residual current circuit breakers or the like.

A line circuit breaker generally has a housing formed from shell-like housing parts, an electromagnetic and a thermal release and a switching mechanism with a latching point, which can be unlatched both manually and by means of the releases. Coupled to the switching mechanism is a contact lever on which a movable contact piece is located which interacts with a stationary contact piece. If, as a result of an overcurrent or a short-circuit current, the latching point is unlatched by the thermal and/or electromagnetic release, the contact lever is pivoted and the contact point is opened.

The electromagnetic release normally has an armature, which is actuated by an electromagnetic field. In the event of a short-circuit current, the armature, with a striker pin coupled thereto, strikes directly against the contact lever and opens the contact point formed by the movable and the stationary contact piece. If, however, no further measures are provided, the contact point will close again, so that it is necessary to continuously open the contact point. For this purpose, the armature is connected to a twin-armed lever, whose other end is connected to a slide, which is arranged displaceably within the housing of the line circuit breaker, so that, in the case of a tripping event, the slide is displaced and the latching point is opened.

The thermal release is usually formed from a bimetallic strip, which heats in the event of a so-called overcurrent and then bends out, the movement of the free end of the bimetallic strip likewise being transferred to the slide so as to unlatch the latching point.

The bimetallic strip, which brings about the thermal tripping, bears directly against the slide. Since the bimetallic strip is heated successively, the slide also needs to withstand the corresponding temperatures, high thermal loading occurring, e.g., in the case of relatively high currents and corresponding characteristic of the switching device.

In the case of line circuit breakers which are produced and offered for sale at present, the arc, once it has been produced, is driven into an arc splitter stack; the region which the arc traverses between the contact point, i.e. between the stationary and the movable contact piece, as far as the arc splitter stack is referred to as the prechamber area. So-called prechamber plates are arranged on both sides of the prechamber area, which prechamber plates are made of ceramic. These two prechamber plates act as insulating parts with respect to the housing inner walls and should prevent the latter from fusing or decomposing. In the case of some line circuit breakers, the prechamber plates are produced from a thermoplastic. When using such a thermoplastic prechamber plate, production and running of the arc bring with them degassing of the prechamber plates which support the arc as it runs into the arc quenching chamber, which is desirable since in this case the thermal loading of the prechamber area is reduced and the current limitation s accelerated. However, in cases in which the arc which has been produced between the contact pieces does not run via arc guide rails to the arc splitter stack, the degassing of thermoplastic prechamber plates which occurs can additionally impede the starting operation, which is undesirable. The prechamber plates are therefore usually produced from a ceramic.

Either thermosetting plastics such as FS131.5 (urea), FS803 (polyester) and FS183 (melamine/phenol) or else thermoplastics such as polyamide 6 (PA6) are used as housing materials for the housings of line circuit breakers. The application area for thermoplastics is at a very different level, however, depending on the principle of action and arrangement of the functional elements within the line circuit breaker. However, thermoplastics can only be used when a certain rated current and a maximum disconnection power are not exceeded.

However, thermoplastics have economic advantages over thermosetting plastics, for example because certain functions or component parts, for example rapid fixing, and other component parts can be dispensed with.

### SUMMARY

An electrical installation switching device of the type mentioned at the outset is disclosed which is improved alongside lower costs.

An electrical installation device is disclosed, e.g., a line circuit breaker, motor circuit breaker or the like, with a housing, which is formed from shell-like housing parts, with an electromagnetic release and a thermal release, with a switching mechanism with a latching point, with a slide, which transfers the movements of the thermal release and the magnetic release to the switching mechanism so as to unlatch it, and with a striker pin, which is connected to the armature of the electromagnetic release and acts on a movable contact piece of a contact point in the event of a short circuit so as to open it, the shell-like housing parts, the slide and the striker pin being made of plastic, wherein at least the slide is formed from radiation-crosslinked thermoplastic, which has been supplied with an additive as a crosslinking promoting agent prior to the irradiation.

### BRIEF DESCRIPTION OF THE DRAWING

The disclosure and exemplary configurations and improvements of the disclosure will be explained and described in more detail with reference to the drawing, in which an exemplary embodiment of the disclosure is illustrated and in which:

FIG. 1 shows a view into an electrical line circuit breaker,

FIG. 2 shows a side view of a slide, and

FIG. 3 shows a striker pin, which can be connected to the armature of the release.

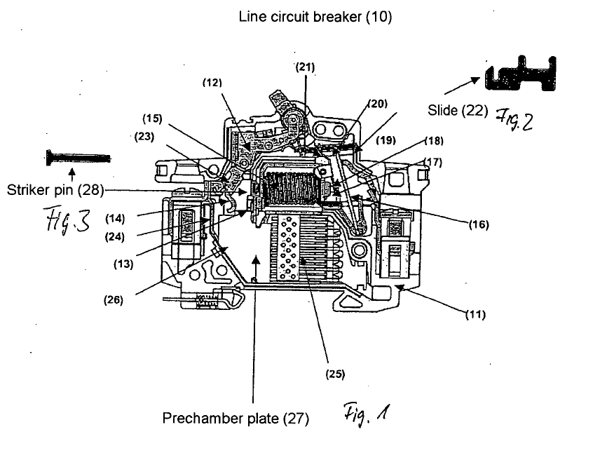

### DETAILED DESCRIPTION

In accordance with a further embodiment of the disclosure, the radiation-crosslinked thermoplastic is also used for the prechamber plates, which laterally cover the prechamber area.

In accordance with a third embodiment of the disclosure, the material is used as the radiation-crosslinked thermoplastic for the housing as well.

Mention has been made above of the fact that the armature, via the striker pin, hits the movable contact piece; radiation-crosslinked thermoplastic is possible for such a striker pin, which is coupled to the armature, as well.

The crosslinking of thermoplastic polymers is a method known per se for improving thermal properties. In this case, the thermoplastic materials are crosslinked by electron beams or gamma rays, it being possible for the crosslinking to be set by means of the dose. So-called crosslinking promoting agents are added to the material as additives. The radiation-crosslinked materials are dimensionally stable to a high degree under the effect of heat, even beyond the previous melting point of the starting material. If a thermoplastic, for example polyamide, polyethylene or polypropylene, is radiation-crosslinked, the thermoplastic material can no longer be melted in a similar way to thermosetting plastic.

As a result, the slide, the prechamber plates, the striker pin and the housing can be produced considerably more inexpensively because the standard thermoplastics are approximately ten times less expensive than the high-temperature thermoplastics.

Similarly, if the prechamber plates are also produced from radiation-crosslinked thermoplastic, considerable cost savings are likewise possible. The use of ceramic entails high costs corresponding to the high material costs. Furthermore, high costs are also incurred for supply devices in the case of ceramic plates and the complexity involved with maintenance on these devices as a result of the high susceptibility to faults of the system is very great. The susceptibility to faults can be attributed to the material property of the ceramic since ceramic is a material which is sensitive to breakage. Broken pieces produced block the system. Furthermore, ceramic is produced in a sintering process, which makes the reproducibility of the dimensions difficult. Occasionally, prechamber plates with inaccurate dimensions are supplied, with the result that the ceramic plates become stuck in the supply system.

Instead of the prechamber plates used nowadays which are made of oxide ceramic, prechamber plates are therefore used according to the disclosure which are produced from a thermoplastic with a special additive (crosslinking promoting agent) by means of radiation-crosslinking. As a result of its crosslinking, the material can no longer melt and the efficiency of manufacture is considerably improved; the component parts have more accurate dimensions and can therefore be supplied more reliably, as a result of which the productivity of the mechanized system is markedly increased.

Instead of the uncrosslinked thermoplastic striker pins used nowadays, radiation-crosslinked thermoplastic striker pins can also be used according to the disclosure. This has the advantage that the temperatures occurring at high current levels cannot result in fusing of the striker pin. This increases the quality and accordingly also ensures device functioning. In order to ensure the same functionality, a high-temperature thermoplastic would need to be used which is economically much less favorable.

The crosslinking results in increased dimensional stability on heating, improved strength and creep properties and reduced thermal expansion for practical use for the housing as well. Furthermore, the wear resistance and the stress-cracking resistance are significantly increased. A further advantage of the crosslinking is an improvement of a fiber/matrix adhesion and the plastic/plastic composite strength.

Housing parts, not least as a result of the different materials, are a variant part, which, corresponding to smaller manufacturing lots in the production of individual parts, need to be supported more often on the assembly units and involve quality risks since there may be a risk of them being mixed up. During the assembly process on final assembly machines, first the housing lower parts are inserted into the machine receptacles before further parts and modules are assembled. The housing cover closes the individual pole for riveting purposes. For such a manufacturing process, so-called late variance is always desired since this has a positive effect both on production costs and on the quality of the products. In the final assembly process in the present prior art, the variance is incorporated early, in contrast. Since thermosetting plastics are considerably more brittle and therefore more susceptible to breakage, problems occur when the housing parts are supplied and in subsequent process steps such as riveting.

Therefore according to the disclosure, the housing can be also produced from the radiation-crosslinked thermoplastic, and independent prechamber plates can be dispensed with if the prechamber plates can be molded into the inner side faces of the housing broad sides.

The disclosure is advantageous in particular as a result of the fact that the housing parts together come to be assembled first in the unirradiated state and therefore also in the uncrosslinked state, and at this point are assembled to form the finished pole in order then to be radiation-crosslinked only if necessary. In this case, it can be ensured that only the devices with relatively stringent thermal requirements being placed on the housing material are subsequently treated.

It should be added that an additive in the form of a crosslinking promoting agent is admixed to the thermoplastics which are intended to be radiation-crosslinked.

A line circuit breaker 10 comprises a shell-shaped housing 11, in which a switching mechanism 12 with a latching point, a fixed contact piece 13, a movable contact piece 14, an electromagnetic release 15 and a thermal release 16 in the form of a bimetallic strip are accommodated. The electromagnetic release 15 has an armature 17, which is connected to an arm 18 of a twin-armed lever 20, which is mounted rotatably at 19 and is coupled with its second arm 21 to a slide 22, which transfers the movement of the armature and therefore the movement of the twin-armed lever 20 to the latching point in the switching mechanism 12.

Furthermore, a thermoplastic striker pin 28 is mounted in the electromagnetic release 15, which striker pin 28 is connected to the armature and whose free end protrudes out of the release at its end facing the contact lever.

In the same way, the free end, which can be bent out, of the bimetallic strip is connected to the slide 22, with the result that the movement of the bimetallic strip 16 is likewise transferred, via the slide, to the switching mechanism or the latching point of the switching mechanism.

During a switch-off operation, the contact lever 23, on which the movable contact piece 14 is arranged, is moved in the clockwise direction into the switch-on position and there comes into the vicinity of an arc guide rail 24, which guides the arc, which is drawn during the opening operation of the contact point 13, 14, into an arc quenching chamber 25. The region 26 in front of the arc quenching chamber is the so-called prechamber area, which is covered on both sides by a prechamber plate 27. Both the slide 22, the prechamber plate 27 and the striker pin 28 is also formed a radiation-crosslinked thermoplastic.

Furthermore, the housing 11 is also produced from such a radiation-crosslinked thermoplastic.

The production can take place by virtue of the fact that either the individual parts, namely the slide and/or the striker pin and/or the prechamber plates and/or the housing, are each produced individually or together from radiation-crosslinked thermoplastic; it is naturally also possible for the line circuit breaker 10 to be assembled completely before the radiation-crosslinking operation and for radiation crosslinking to be carried out subsequently, if required, for the completely assembled line circuit breaker.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An electrical installation device, in particular a line circuit breaker, motor circuit breaker or the like, with a housing, which is formed from shell-like housing parts, with an electromagnetic release and a thermal release, with a switching mechanism with a latching point, with a slide, which transfers the movements of the thermal release and the magnetic release to the switching mechanism so as to unlatch it, and with a striker pin, which is connected to the armature of the electromagnetic release and acts on a movable contact piece of a contact point in the event of a short circuit so as to open it, the shell-like housing parts, the slide and the striker pin being made of plastic, wherein at least the slide is formed from radiation-crosslinked thermoplastic, which has been supplied with an additive as a crosslinking promoting agent prior to the irradiation.

2. The electrical installation device with at least one prechamber plate, which covers the contact point laterally, as claimed in claim 1, wherein the prechamber plate is formed from radiation-crosslinked thermoplastic, which has been supplied with an additive as a crosslinking promoting agent prior to the irradiation.

3. The electrical installation device as claimed in claim 1, wherein the striker pin is made of radiation-crosslinked thermoplastic, which has been supplied with an additive as a crosslinking promoting agent prior to the irradiation.

4. The electrical installation device as claimed in claim 1, wherein the shell-like housing parts are made of radiation-crosslinked thermoplastic, which has been supplied with an additive as a crosslinking promoting agent prior to the irradiation.

5. The electrical installation device as claimed in claim 1, wherein the prechamber plates are integrated in the housing or are integrally connected thereto.

6. A method for producing an electrical installation device as claimed in claim 1, wherein the plastic parts are produced from thermoplastic, and in that the installation device is irradiated as a whole once it has been completely assembled, so that the thermoplastic becomes a radiation-crosslinked thermoplastic.

7. The electrical installation device as claimed in claim 2, wherein the striker pin is made of radiation-crosslinked thermoplastic, which has been supplied with an additive as a crosslinking promoting agent prior to the irradiation.

8. The electrical installation device as claimed in claim 3, wherein the shell-like housing parts are made of radiation-crosslinked thermoplastic, which has been supplied with an additive as a crosslinking promoting agent prior to the irradiation.

9. The electrical installation device as claimed in claim 4, wherein the prechamber plates are integrated in the housing or are integrally connected thereto.

10. A method for producing an electrical installation device as claimed in claim 5, wherein the plastic parts are produced from thermoplastic, and in that the installation device is irradiated as a whole once it has been completely assembled, so that the thermoplastic becomes a radiation-crosslinked thermoplastic.
